(19) United States
(12) Patent Application Publication
(10) Pub. No.: US 2011/0093791 A1
(43) Pub. Date: Apr. 21, 2011

(54) Managing activity reuse in a collaborative computing environment

(75) Inventors: Joann Ruvolo, San Jose, CA (US); Justin Lessler, Baltimore, MD (US); Thomas P. Moran, Palo Alto, CA (US); Michael Muller, Medford, MA (US); John C. Tang, Palo Alto, CA (US); Daniel M. Gruen, Newton, MA (US); Paul B. Moody, Hyde Park, VT (US); Robert J. Stachel, Waltham, MA (US); Suzanne O. Minassian, Boston, MA (US)

(73) Assignee: International Business Machines Corporation, Armonk, NY (US)

(21) Appl. No.: 11/040,259

(22) Filed: Jan. 21, 2005

(51) Int. Cl. G06F 3/01

(52) U.S. Cl. 715/751

(57) ABSTRACT

A method, system and apparatus for managing activity reuse in a collaborative environment. The method can include the step of creating a new activity instance based upon an existing activity instance. Specifically, the creating step can include the steps of selecting an activity template and creating the new activity instance based upon the selected activity template and/or selecting a portion of an existing activity instance and creating the new activity instance based upon the selected portion. In either case, the method further can include the step of applying changes to the selected portion of the existing activity instance to the new activity instance. Finally, the method can include the step of annotating the new activity instance to refine the new activity instance for reuse. For instance, the annotating step can include coordinating a collaborative annotation of the new activity instance as an activity-in-progress.

### BACKGROUND OF THE INVENTION

1. Statement of the Technical Field

The present invention relates to the field of collaborative computing and more particularly to the creation and management of activities in a collaborative computing environment.

2. Description of the Related Art

Collaborative computing refers to the use by two or more end users of a computing application in order to achieve a common goal. Initially envisioned as a document sharing technology among members of a small workgroup in the corporate environment, collaborative computing has grown today to include a wide variety of technologies arranged strategically to facilitate collaboration among members of a workgroup. No longer merely restricted to document sharing, the modern collaborative environment can include document libraries, chat rooms, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, most goals and objectives can be achieved only through the participation of a multiplicity of individuals, each serving a specified role or roles in the process. Consequently, to provide computing tools designed for use only by one of the individuals in the process can be short sighted and can ignore important potential contributions lying among the other individuals involved in the process.

Personal information managers, project management systems and workflow management systems represent three such computing applications which attempt to manage a process leading to an objective, leveraging of the participation of many individuals in the process. Considering first the personal information manager (PIM), in a PIM, a single end user can establish a calendar of events and a to-do list of tasks which are to be performed by the end user. To the extent that a task is to be performed by another individual, the end user only can establish a task reminding the end user to monitor the completion of the task by the other individual. PIMs do permit the calendaring of events among different individuals, but the calendaring operation only can “invite” others to calendar the event within the personal information manager of other users.

Project management systems provide means for an individual or a group to define and track project stages with strictly-specified interdependencies. In a traditional project management system, the phases of a project can be defined from start to finish and a timeline can be generated for the project. Utilizing the timeline, it can be determined when particular phases of the project have been completed and when a subsequently scheduled phase of the project can begin. To the extent that the timing of one phase of the project changes, the remaining project phases can be adjusted to accommodate the changed timing. Similarly, if the project requires the use of limited resources, and the allocation of one such resource changes, the remaining project phases that depend on that resource can be adjusted to accommodate the reduction of that resource. A major strength of project management systems is their maintenance of these kinds of strict interdependencies. In addition, in many project management systems, particular people can be assigned to particular phases of the project.

In these ways, the execution of a project can be better managed by a project manager using the project management system's control over timing, resources, and people. Notably, in most project management systems, the interdependencies are specified by the project manager, and the other users are relegated to the subordinate tasks of confirming that components have been completed, or indicating changes in resources. Changes in interdependencies are typically executed only by the project manager.

Workflow management systems differ substantially from PIMs and project management systems. In a workflow management system, different computing processes can be linked together by an electronic specification. Moreover, in a workflow management system, it is not important whether all of the computing processes are managed by a single entity and different ones of the computing processes can be distributed about a network of diverse computing resources. In the latter circumstance, the specifying electronic document merely need reference the pertinent computing processes in a way in which the processes can be located in the value chain. Most importantly, a workflow specifies a structure of distributed processes, executed by a combination of electronic and human agents, with rigid contingencies that are enforced among these agents.

Learning management systems can be viewed as collaborative forms of the project manager. In a typical learning management system, a project species—namely a syllabus—can be defined to include one or more assignments. A class can be created from the syllabus, one or more instructors can be assigned to the class and one or more students can be enrolled in the class. Advantageously, additional collaborative tools can be provided to facilitate the execution of the course, including a chat room, document library and discussion forum, to name a few.

Notwithstanding the foregoing, individualized PIMs, project management systems, and workflow management systems, as well as collaborative learning management systems, do not account for the actual nature of a coordinated set of collaborative tasks conducted by people, such as an activity. An activity, unlike a typical project or workflow, refers to objects, actions, and persons in the real world, and provides a computerized representation of selected aspects of those objects, actions, and persons.

Creating an activity collaboratively so that the activity can support a collaborative objective effectively can be a time consuming, iterative process. First, an activity can be created and utilized. Subsequently, upon reflection, changes can be proposed by the end user to enhance the effectiveness of the activity. As such, when creating a subsequent activity to achieve the same or similar objective, the changes can be incorporated into the new activity design. While in the isolated setting of an individual user this iterative process of refining an activity can be acceptable albeit clunky, the same cannot be said of the collaborative environment where the collective experiences of different collaborators cannot be easily corralled when refining an activity.

### SUMMARY OF THE INVENTION

The present invention addresses the deficiencies of the art in respect to activity management and provides a novel and non-obvious method, system and apparatus for creating and managing an activity through reuse in a collaborative environment. In a preferred aspect of the present invention, a unified activity manager for use in a collaborative environment can include an activity list view having a listing of activities. The unified activity manager further can include an activity view having a rendering of properties associated with a selected activity in the activity list view. The unified activity manager yet further can include a persons and roles view having at least a listing of collaborators available for association with the selected activity in the activity list view. Finally, the activity manager can include a reuse processing engine.

The reuse processing engine can include template logic programmed to create new activities from existing activity templates. The reuse processing engine also can include borrowing logic programmed to create new activities from selected portions of existing activities. To facilitate the creation of new activities, the reuse processing engine can include a search engine configured to search for selected activity templates or selected portions of the activities. Finally, the reuse processing engine can include reflection logic programmed to annotate portions of completed activities. Specifically, the reflection logic can include programming to coordinate a collaborative annotation of selected activities as an activity-in-progress.

A method for managing activity reuse in a collaborative environment can include the step of creating a new activity instance based upon stored activity representations, such as activity templates or previously created activity instances. Specifically, the creating step can include the steps of selecting an activity template and creating the new activity instance based upon the selected activity template. Alternatively, the creating step can include the steps of selecting all or a portion of an existing activity instance and creating the new activity instance based upon the selected portion.

In either case, the method further can include the step of applying changes to the selected portion of the existing activity instance to the new activity instance. Finally, the method can include the step of annotating the new activity instance to refine the new activity instance for reuse. For instance, the annotating step can include coordinating a collaborative annotation of the new activity instance as an activity-in-progress.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a unified activity manager which has been configured in accordance with the present invention;

FIG. 2 is a block diagram illustrating an architecture for the unified activity manager of FIG. 1; and,

FIG. 3 is a flow chart illustrating a process for building an activity through reuse in the unified activity manager of FIG. 1.

### DETAILED DESCRIPTION OF THE PREFERRED EMBODIMENTS

The present invention is a method, system and apparatus for creating and managing an activity through reuse in a collaborative environment. In accordance with the present invention, a new activity instance can be established based upon at least one prior activity instance or template. The new activity instance can be utilized collaboratively in the collaborative environment and, subsequently, the new activity instance can be refined through a reflection process such that the new activity instance can be reduced to a template or simply reused as a base activity instance for yet another activity instance at a later time.

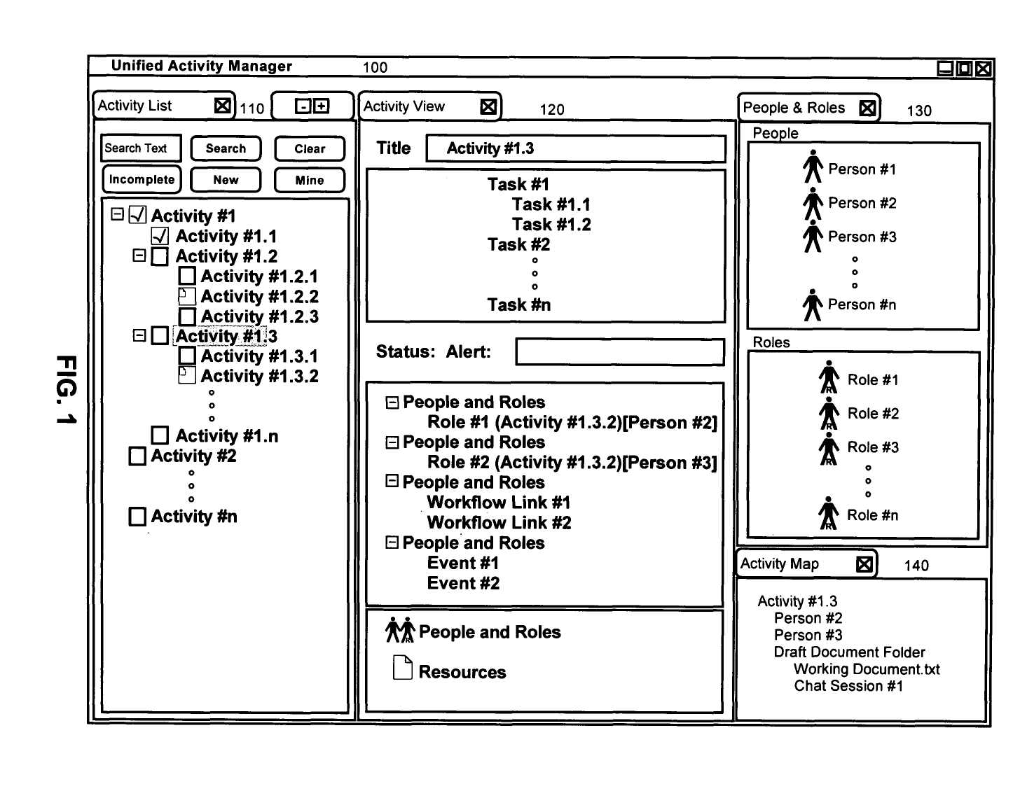

In further illustration, FIG. 1 is a pictorial illustration of a unified activity manager which has been configured in accordance with the present invention. The unified activity manager 100 can include several views including an activity list view 110, an activity view 120 and a people and roles view 130. The activity list view 110 can include a listing of one or more activities. Each activity can be decomposed into zero or more dependent activities, which together comprise a richer description of the work summarized in the original activity. Each of these dependent activities is itself an activity, but appears in a subactivity-relationship to the original activity. This process of defining activities in subactivity-relationship may be extended to any desired level of dependent description.

The activity view 120 can include a description of a task that is contained within the activity. The task description can include one or more tasks associated with the activity. Additionally, tasks can be decomposed into zero or more dependent tasks, which together comprise a richer procedural specification of the original task. Each of these dependent tasks is itself a task, but appears in a subtask-relationship to the original task. This process of specifying tasks in subtask-relationship may be extended to any desired level of dependent specification.

The activity view 120 further can include a detailed listing of the properties of a selected activity in the activity list view 110. Specifically, the detailed listing can include a listing of collaborators (people) specified for the activity. Also, the detailed listing can include a listing of collaborator roles (roles) specified for the activity. Further, the detailed listing can include a listing of events specified for the activity. Finally, the detailed listing can include a listing of links to internal workflows, external workflows or both.

Finally, the peoples and roles view 130 can include a listing of collaborators in the collaborative environment available for assignment to a specified activity in the activity list view 110. The peoples and roles view 130 also can include a listing of collaborative roles in the collaborative environment available for assignment to a specified activity in the activity list view 110. In this regard, a role can be compared to a person in that a person references a specific identity and a role references only a class of persons.

Finally, an activity map 140 can be provided. The activity map 140 can include a listing of electronic mail messages, calendar entries, documents, files and file folders, and applications, such as an application share, discussion thread or chat session, to name a few.

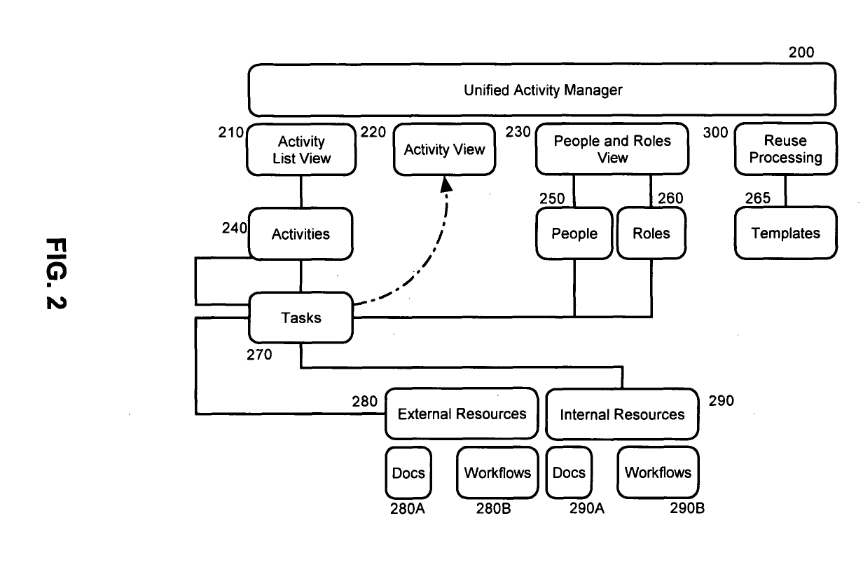

Turning now to FIG. 2, a block diagram is shown which illustrates the architecture for the unified activity manager of FIG. 1. The architecture can include the unified activity manager 200 which can have an activity list view 210, an activity view 220 and a people and roles view 230. The activity list view 210 can include one or more activities 240, each activity 240 having one or more tasks 270 or even other activities 240 defined through a sub-activity relationship. The activity view 220 can include a visual rendering of the properties of a selected one of the activities 270. Finally, the people and roles view 230 can include one or more people 250 and one or more roles 260. Importantly, references to the people 250 and roles 260 can be included in the tasks 270.

In accordance with the present invention, each of the activities 270 optionally can include links to both internal resources 290 and external resources 280. The internal resources 290 can include internally disposed documents 290A and internally specified workflows 290B to name only two. Similarly, the external resources 280 can include externally disposed documents 280A and externally specified workflows 280B. Other resources not shown can include references to internally available collaborative tools including application shares, chat sessions, document libraries, and e-mail messages, to name a few.

Utilizing the architecture of FIG. 2, activities can be created and managed so as to facilitate the collaborative achievement of a goal without requiring the use of a rigid, non-collaborative, conventional workflow or project management system. Rather, the activities can represent an informal and flexible structuring of to-dos and resources which can permit the collaborative execution of the activity in a conversational manner, regardless of the sequence of completion of the to-dos and irrespective of whether all tasks in the activity are completed.

Importantly, the unified activity manager 200 yet further can include an activity reuse module 300. The activity reuse module 300 can be configured to create new ones of the activities 240 in the activity list view 210 based upon portions of existing ones of the activities 240 such as branches of the hierarchy of activities 270. The activity reuse module 300 further can be configured to create new ones of the activities 240 based upon one or more pre-stored activity templates 265. The templates 265 can be an abstracted or pruned from an instance of one of the activities 240. In its purest form, the templates 265 can include a mere activity structure which lacks substantive content.

In either case, values for assigned elements of an activity can be scoped to facilitate the reuse of the activity template. For instance, some elements can enjoy a local scope to ensure that the value for the element remains relative to the ultimate instance of the activity template. Alternatively, some elements can enjoy a global scope to ensure that the value for the element remains uniform throughout all instances of the activity template irrespective of the relative characteristics of an instance of the activity template.

Notably, a prime value proposition in unifying activity management is to support a set of collaborators in an organization in the reuse of the collective and individual experiences of the collaborators. Experience can be obtained by engaging in activities. Hence, a set of activities incorporates organizational experiences, culture and practices. By reducing individual activities into a template or pattern, the collaborative experiences of an organization can be iteratively refined and reused to the advantage of the organization. To achieve a desired level of reuse, several aspects of reuse can be applied including borrowing, finding, reflecting and refining.

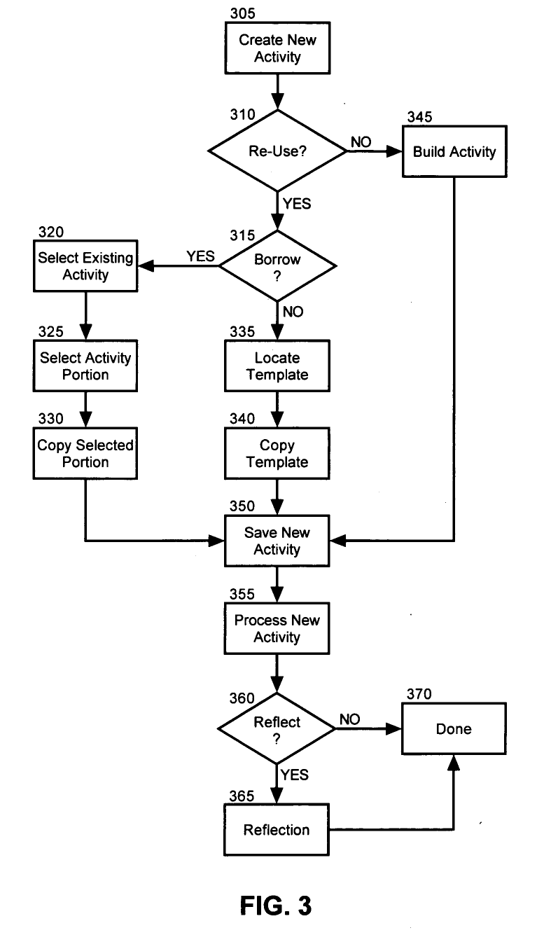

In further illustration, FIG. 3 is a flow chart illustrating a process for building an activity through reuse in the activity manager of FIG. 1. Beginning in block 305, a new activity can be established and in decision block 310, it can be determined if the new activity is to be created utilizing reuse. If not, the activity can be created by adding to the activity the requisite selection of tasks, resources, collaborators and roles to produce a new activity instance. Otherwise, the activity can be created based upon the reuse of an activity pattern (portions of an existing activity instance), or an activity template (an abstracted form of an activity instance).

Specifically, in decision block 315 it can be determined whether the activity is to be created by borrowing elements of an existing activity instance, or whether the activity is to be created based upon an existing activity template. If the activity is to be created by borrowing elements of an existing activity instance, in block 320 an existing activity instance can be selected. In block 325 a portion of the existing activity instance can be selected for use in the new activity instance. Subsequently, in block 330 the selection portion of the existing activity instance can be copied into the new activity instance.

Optionally, meta-information can be collected for the new activity instance to indicate which portions of the existing activity instance had been “borrowed” into the new activity instance. This meta-information can be analyzed separately to recognize often borrowed portions of existing activity instances in order to identify recurring patterns of reuse. Moreover, as yet another option, a live linkage can be maintained as between the existing activity instance and the new activity instance such that changes to the borrowed portion of the existing activity instance can be reflected in the new activity instance.

Returning to decision block 315, if it is determined that the activity is to be created based upon an existing template in block 335 an existing activity template can be located. In this regard, the process of locating a template can range from a simple text search either across the content of the template such as tasks, sub-activities, collaborators, roles or resources, or meta-information defined for the template including a template name. The searching process further can consider usage frequency of a template. Optionally, a similar searching process can be utilized for locating content for borrowing in block 325.

Once a desired template has been located, in block 340 the content of the template can be copied into the new activity instance and block 350 the new activity instance can be saved. In block 355 the new activity instance can be processed irrespective of the manner in which the activity instance had been created. Subsequently, in decision block 360 it can be determined whether reflection in respect to the new activity instance is warranted. Reflection is the process of assessing an activity and refining the activity to permit its reuse. Reflection can occur not only once an activity has been completed, but also in the course of completing an activity.

In decision block 360, if reflection is warranted, in block 365 a reflection process can be undertaken. The reflection process can include the annotation of the elements of the new activity instance. Through annotative markings of elements of an activity instance, a view of the activity instance can be filtered to only include the marked elements providing for an easier borrowing process. The reflection process also can include the location of multiple activity instances sharing common characteristics or content. The common characteristics or content can represent organizational best practices and culture and, accordingly, can be incorporated into a revised form of the activity instance or an activity template.

Optionally, the reflection process can include an activity-in-progress. In an activity-in-progress, an activity instance can be marked as an activity-in-progress and different collaborators can separately annotate the activity instance or any of the elements of the activity instance. Tasks can be added by the different collaborators to the activity instance to indicate internal instructions for preparing the activity instance for reuse. Once all of the newly added tasks have been completed confirming the preparation of the activity instance for reuse, the activity-in-progress marking can be removed and the activity instance can be transformed into a template or merely reused as a pattern.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A unified activity manager for use in a collaborative environment comprising:
an activity list view comprising a listing of activities;
an activity view comprising a rendering of properties associated with a selected activity in said activity list view;
a persons and roles view comprising at least a listing of collaborators available for association with said selected activity in said activity list view; and,
a reuse processing engine.

2. The unified activity manager of claim 1, wherein said, activity view further comprises a listing of collaborators associated with said selected activity in said activity view, a listing of roles associated with said selected activity in said activity list view, a listing of resources associated with said selected activity in said activity list view, and a listing of events associated with said selected activity in said activity list.

3. The unified activity manager of claim 1, wherein said reuse processing engine comprises template logic programmed to create new ones of said activities from existing activity templates.

4. The unified activity manager of claim 1, wherein said reuse processing engine comprises borrowing logic programmed to create new activities from selected portions of existing ones of said activities.

5. The unified activity manager of claim 3 wherein said reuse processing engine comprises a search engine configured to search for selected ones of said activity templates.

6. The unified activity manager of claim 1 wherein said reuse processing engine comprises a search engine configured to search for selected portions of said activities.

7. The unified activity manager of claim 1, wherein said reuse processing engine comprises reflection logic programmed to annotate portions of a completed one of said activities.

8. The unified activity manager of claim 7, wherein said reflection logic further comprises programming to coordinate a collaborative annotation of a selected one of said activities as an activity-in-progress.

9. A method for managing activity reuse in a collaborative environment, the method comprising the step of creating a new activity instance based upon an existing activity instance.

10. The method of claim 9, wherein said creating step comprises the step of selecting an activity template and creating said new activity instance based upon said selected activity template.

11. The method of claim 9, wherein said creating step comprises the step of selecting a portion of an existing activity instance and creating said new activity instance based upon said selected portion.

12. The method of claim 11, further comprising the step of applying changes to said selected portion of said existing activity instance to said new activity instance.

13. The method of claim 9, further comprising the step of annotating said new activity instance to refine said new activity instance for reuse.

14. The method of claim 13, wherein said annotating step comprises coordinating a collaborative annotation of said new activity instance as an activity-in-progress.

15. A machine readable storage having stored thereon a computer program for managing activity reuse in a collaborative environment, the computer program comprising a routine set of instructions which when executed by a machine, causes the machine to perform the step of creating a new activity instance based upon an existing activity instance.

16. The machine readable storage of claim 15, wherein said creating step comprises the step of selecting an activity template and creating said new activity instance based upon said selected activity template.

17. The machine readable storage of claim 15, wherein said creating step comprises the step of selecting a portion of an existing activity instance and creating said new activity instance based upon said selected portion.

18. The machine readable storage of claim 17, further comprising an additional set of instructions which when executed by the machine cause the machine to further perform the step of applying changes to said selected portion of said existing activity instance to said new activity instance.

19. The machine readable storage of claim 15, further comprising an additional set of instructions which when executed by the machine cause the machine to further perform the step of annotating said new activity instance to refine said new activity instance for reuse.

20. The machine readable storage of claim 19, wherein said annotating step comprises coordinating a collaborative annotation of said new activity instance as an activity-in-progress.
